(19) United States
(12) Patent Application Publication
(10) Pub. No.: US 2025/0161144 A1
(43) Pub. Date: May 22, 2025

(54) Roller Attachment Exercise Device

(71) Applicant: David Nelson, Pawleys Island, SC (US)

(72) Inventor: David Nelson, Pawleys Island, SC (US)

(21) Appl. No.: 18/514,152

(22) Filed: Nov. 20, 2023

(51) Int. Cl. A61H 15/00; A63B 23/04

(52) U.S. Cl. CPC A61H 15/00; A63B 23/0405; A61H 2015/0014; A61H 2201/0107; A61H 2201/0119; A61H 2201/1261; A61H 2205/081; A63B 2023/0411

(57) ABSTRACT

A roller attachment for an exercise machine includes a frame member, a roller attached to the frame member via an axle member so that the roller may rotate about a longitudinal axis, and a bracket for attachment to an exercise machine, structure, or to another desired support. The roller attachment is removably attachable to the frame of a home gym system, so that a user may perform squat exercises with his or her back pressed against the roller. As the user performs squats, the roller rotates in one direction when the user is moving downwardly into the squat position, and the roller rotates in an opposed direction when the user is moving upwardly, back into an upright position. The roller attachment helps the user to maintain balance, and further, assists in maintaining proper posture during the squatting exercises.

### FIELD OF THE INVENTION

The present invention is directed to a roller attachment exercise device. More specifically, the present invention includes a frame member, a roller attached to the frame member so that the roller may rotate about a longitudinal axis, and a bracket attached to the frame for attachment to an exercise machine or some other stationary support.

### BACKGROUND OF THE INVENTION

Many types of exercise devices are on the market today. Such devices may be as simple as a set of barbells for weightlifting exercises, or may be more complex, such as power racks, squat racks, cages and home gym systems, which typically include a set of weights that are attached to various components via cable or the like, to provide a number of different weightlifting exercises.

One popular exercise is performing squats, where a person essentially squats down, bending his or her knees and lowering their upper body into a squatting position, and then moving their upper body back into a standing position. This exercise may be performed either with additional weights, or without weights. To perform these types of squatting exercises, it is preferable for the person to maintain proper posture. It would be desirable to provide a mechanism that helps the squatter to maintain this proper posture, and to provide some support to the person for purposes of maintaining their balance, as well.

Various types of devices have been developed to be of assistance in performing squats. The following references disclose some of these devices, and are hereby incorporated herein by reference, in their entireties:

Canadian Patent No. CN110681120 Deep Squatting Frame with Back Massage Function

The invention discloses a deep squatting frame with a back massage function. The squat frame comprises a supporting part and an arm force part; the supporting part and the arm force part are connected together through a rotating shaft; the supporting part is provided with a first supporting rod, a second supporting rod and a third supporting rod; the supporting part forms a triangular structure so as to be stable; the outer side of the arm strength part is provided with a handle, and the arm strength part is provided with a slideway and a bolt which can move along the slideway; arm strength portion is equipped with first arm strength pole and second arm strength pole, first arm strength pole and second arm strength pole between be equipped with the massage stick, the increase of massage stick can massage the back when the training, is favorable to eliminating fatigue, promotes qi and blood circulation, strengthens human pliability.

Canadian Patent No. CN202146553 Standing Massager

The utility model provides a standing massager and belongs to the field of sports and training devices. A support (1) is fixed on a base (6), handles (2) are welded at the upper end of the support (1), a rotary plate fixing rack (4) is fixed on the support (1) through a connecting rod (5), and a rotary plate (3) is arranged inside the rotary plate fixing rack (4). When the device is used, a user stands back to the massager, holds the handles by the two hands, allows the lumbar and back to be leaned against the rotary plate, and moves the body up and down to massage the lumbar and back. The standing massager has a simple structure and a small size, is convenient to transport regardless of space and time, is easy to operate, has a wide application range, and is a necessary body-building device for schools and families.

U.S. Pat. No. 4,500,089 Weight Lifting Lower Back Exercising Machine

This machine includes a saddle-type seat for supporting the user in substantially an upright position with the legs being maintained in position during use of the machine. A user-actuated lever is provided with a padded roller on one end thereof. The padded roller is adapted to engage the back of the user at a position substantially in alignment with the shoulder blades and the other end of the lever is pivotally supported at a position in substantial alignment with the waist of the user. The other end of the user-actuated lever is operatively connected to weights. The connection between the user-actuated lever and the weights includes a variable radius cam for providing a variable resistance force to lifting and lowering the weights with corresponding movement of the user between a first position with the spine in a forwardly bent position and a second position with the spine in a substantially straight position to provide a full range exercising of the muscles associated with the lower back of the user.

U.S. Pat. No. 7,086,992 Posture Correction Exercise Device

A posture correction exercise device is disclosed to aid in correcting the common postural condition of kyphosis-lordosis by aiding in the exercise of the spinal erectors to strengthen the erectors to pull the user's spine and torso backward into normal alignment and by exercise of the mid-trapezious, rhomboid and posterior deltoid muscles to strengthen these muscles to pull the user's shoulder blades together and force the shoulders into normal alignment. The device operates by seating the user upon a declined seat to provide increased resistance by gravity. The device provides resistance to backward movement of user's body and resistance to backward rotation of user's arms. The hands of the user are positioned in supinated palms-up hand positions to increase the training effect of the backward rotation of the user's arms.

U.S. Pat. No. 7,104,939 Apparatus for Back Therapy and Multiple Exercises

A freestanding back therapy and multiple exercise station on which various therapeutic, stretching, bending, twisting, extension and inversion exercises may be carried out utilizing the user's weight for fully flexing and decompressing the spine and strengthening the trunk and back muscles of the user. The station has a frame of tubular construction with a floor engaging base, front and rear vertical upright members, a horizontal top member extending between upper ends thereof, and a cushioned forearm pad on each said horizontal member with handgrips at outer of the horizontal top members. A lower pair of vertically spaced padded cross members extend transversely between the rear vertical upright members to serve as foot supports. A central upright member is connected at a lower end with at least one padded cross member and has a forward and angularly upward extending upper portion. A backrest pad is mounted the central upright member. An upper pair of parallel vertically spaced padded tubular members extend laterally outward from each side of the central upright member near its upper portion to selectively serve either as handgrips or as elevated or leg or foot supports when performing exercises. A removable rotatable cylindrical cushioned roller is may be mounted transversely between the horizontal top members to serve as a back engaging roller or a seating surface when performing exercises. Various auxiliary exercise apparatus may be removably connected with the station for performing a variety of exercises.

U.S. Pat. No. 7,981,010 Exercise Machine with Multi-Function User Engagement Device

An exercise machine has a main frame and a user support movably mounted relative to the main frame for movement between a start position and an end position during an exercise. At least one multi-function user engagement device is movably mounted relative to the frames for engagement and actuation by a user during an exercise, and a connecting linkage translates movement of the user engagement device to movement of the user support. The user engagement device has two different modes of operation selectable by a user for performing different exercises which exercise distinct muscles or muscle groups. A load provides resistance for both exercises.

U.S. Pat. No. 8,025,615 Exercise Roll Bar Device

An exercise device and method that is suitable to provide lateral stabilization of the exerciser performing a squatting exercise is provided. The device includes an exercise bar, and wheels that are located, in some implementation, at least the width of a doorframe. Some embodiments of the exercise bar further include a means to adjust its length and to cause vertical resistance. The lateral stabilization method includes the steps of aligning the wheels of the wheeled exercise bar to properly engage the vertical guiding surface; and engaging the vertical guiding surface with the wheels of the wheeled exercise bar such that the wheels roll with sufficient frictional or normal force thereon to provide lateral stabilization to the user.

U.S. Pat. No. 9,662,536 Squat Rack

A squat rack includes a frame, a lifting unit, a body support unit, an elastic unit and a tread unit. The frame includes a horizontal portion, a vertical portion connected to the horizontal portion, and a handle connected to the vertical portion. The lifting unit is pivotally connected to the frame. The body support unit is connected to an upper portion of the lifting unit. The elastic unit is provided between the frame and the lifting unit and adapted for raising the lifting unit from the frame. The tread unit is connected to the horizontal portion of the frame, between the handle and the body support unit in a horizontal direction. While exercising, a user can set his or her feet on the tread unit, hold the handle with his or her hands, and lean on the lifting unit to gain support from the elastic unit.

U.S. Pat. No. 10,251,807 Massage Attachment Device and System and Method Therefor

A massage attachment device has a roller bar with a massage sleeve slidably positioned thereon. In one embodiment, the massage attachment device is configured to be removably coupled to a wall mounted rack apparatus. In another embodiment, the massage attachment device is configured to be removably coupled to a portable mounted rack apparatus. A further embodiment of the massage attachment device is configured to be removably coupled to existing squat rack apparatuses. The massage attachment device may be used to massage various muscles, and may be particularly useful following a workout session.

### U.S. Patent Application No. 20120028765 Adjustable Standing Muscular Releasing and Stretching Exercise Device

The present invention is an adjustable standing muscular releasing and stretching exercise device for a user. The device has a vertical linear column base, a support handle that can be vertically moved and attached along the linear base, a pair of adjustable releasing rollers on a horizontal bar with a roller connection that is movably connected to the linear base, a horizontal floor base that is attached to and supports the linear base, a raised non-skid foot platform that is attached to and extends over said floor base and an adjustable non-skid calf step perpendicularly and slidably attached to said foot platform.

### U.S. Patent Application No. 20120028765 Adjustable Standing Muscular Releasing and Stretching Exercise Device

The present invention is an adjustable standing muscular releasing and stretching exercise device for a user. The device has a vertical linear column base, a support handle that can be vertically moved and attached along the linear base, a pair of adjustable releasing rollers on a horizontal bar with a roller connection that is movably connected to the linear base, a horizontal floor base that is attached to and supports the linear base, a raised non-skid foot platform that is attached to and extends over said floor base and an adjustable non-skid calf step perpendicularly and slidably attached to said foot platform.

### SUMMARY OF THE INVENTION

The present invention, in one embodiment, includes a roller attachment for an exercise machine, wherein the roller attachment includes a frame member, a roller attached to the frame member so that the roller may rotate about a longitudinal axis, and a bracket for attachment to an exercise machine, or to another desired support.

In one embodiment, the roller is preferably formed from high-density foam, or alternatively, may formed from any suitable material and includes padding on the outer portion thereof, so that the roller is more comfortable on a user's back. The roller attachment preferably includes a bracket, or some other means of attachment, for removably attaching the roller attachment to an exercise machine or the like.

In a preferred embodiment, the bracket includes a fixed post that may be inserted into a hole that is positioned on a frame member of a home gym exercise system. The bracket may further include a C-shaped member, wherein each side of the C-shaped member abuts and frictionally engages the frame member of the home exercise gym, and serves as a stabilizer, in order to maintain the proper position of the roller attachment during operation. To attach this embodiment, a user orients the roller in a vertical orientation, slides the fixed post of the bracket into a hole on the frame of the home exercise gym system, and then rotates the roller attachment into a horizontal orientation so that the C-shaped member engages three sides of the frame of the home exercise gym system. To remove the roller attachment, the procedure is simply reversed, where the user rotates the roller attachment to a vertical orientation, thereby disengaging the C-shaped member from the frame of the home gym system, and then pulls the roller attachment away from the frame of the home gym system to remove the fixed post from the hole therein.

The roller attachment is useful for improving stability and balance, and serves to increase strength and muscle isolation while facilitating user safety and self-confidence. The roller attachment provides assistance for individuals who cannot complete a traditional squat method, struggle to get into and out of a sitting position, and provides a suitable alternative for users with shoulder or neck issues that prevent them from completing a traditional barbell squat. Thus, the roller attachment, in addition to being a squat assistance device, is also a therapeutic device that provides the benefits of myofascial release.

### DESCRIPTION OF THE DRAWINGS

These and other features, aspects, and advantages of the present invention will become better understood with regard to the following description and accompanying drawings where:

FIG. 1 is a top perspective view of one embodiment of a roller attachment exercise device having a frame member including a longitudinal support, a pair of side supports, each side support connected to opposed ends of the longitudinal support, a rod or axle member disposed between the side supports, and a roller that is rotatably attached to the rod or axle member, so that the roller may rotate about a longitudinal axis, and a bracket having a fixed post along with a C-shaped member for attachment to a home gym system, or the like;

FIG. 2 is a side perspective view of one embodiment of a roller attachment exercise device having a frame member including a longitudinal support, a pair of side supports, each side support connected to opposed ends of the longitudinal support, a rod or axle member disposed between the side supports, and a roller that is rotatably attached to the rod or axle member, so that the roller may rotate about a longitudinal axis, and a bracket having a fixed post along with a C-shaped member for attachment to a home gym system, or the like;

FIG. 3 is a side perspective view of one embodiment of the bracket member, including a fixed post and a C-shaped member, which is used for removable attachment to a home gym system, or the like;

FIG. 4 is a perspective view of one embodiment of a roller attachment device in process of being attached to (or detached from) a frame of a home gym system, wherein the roller attachment is oriented in a generally vertical position, so that the fixed post member is inserted into (or removed from) a hole disposed in the frame of the home gym system, and wherein the C-shaped member is disengaged from the frame of the home gym system; and

FIG. 5 is a perspective view of one embodiment of a roller attachment device that is removably attached to a frame of a home gym system, wherein the roller attachment is oriented in a generally horizontal orientation in which the roller attachment device is positioned for use, so that the fixed post member is positioned within a hole in the home gym frame member, and the C-shaped member is engaged with the frame member of the home gym system so that the three sides of the C-shaped member are disposed about and frictionally engage three sides of the home gym system frame member.

### DESCRIPTION OF THE INVENTION

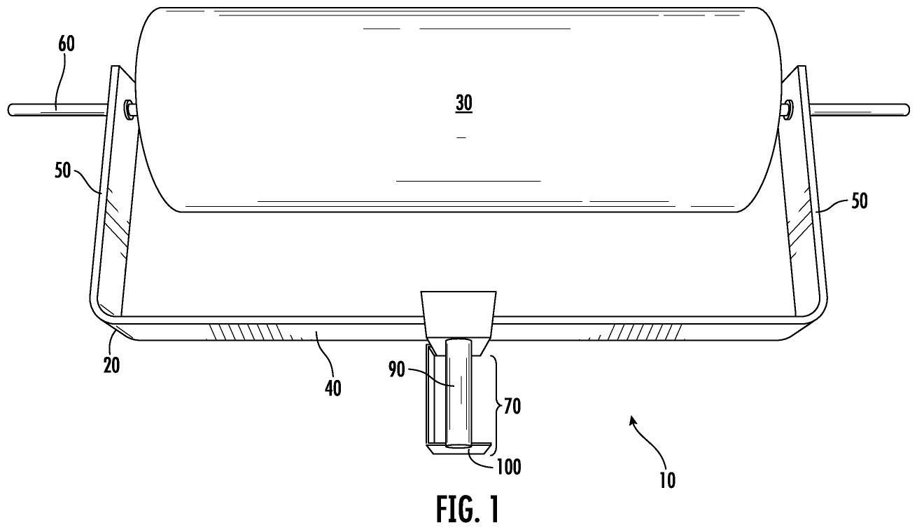

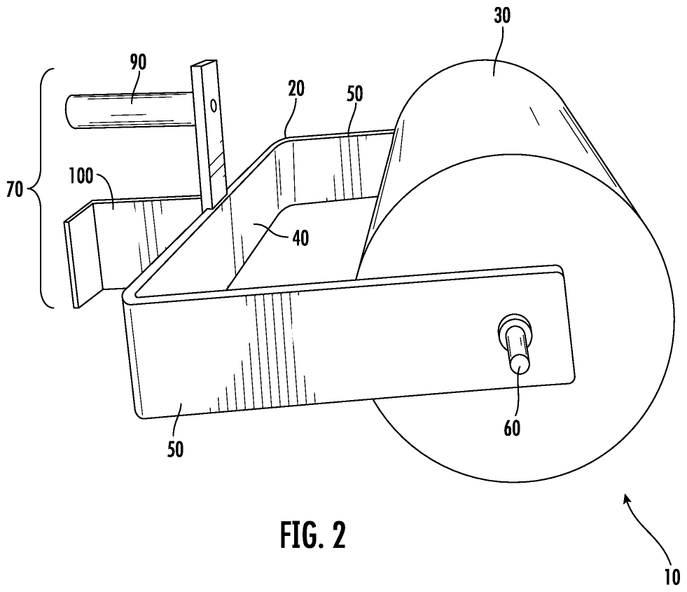

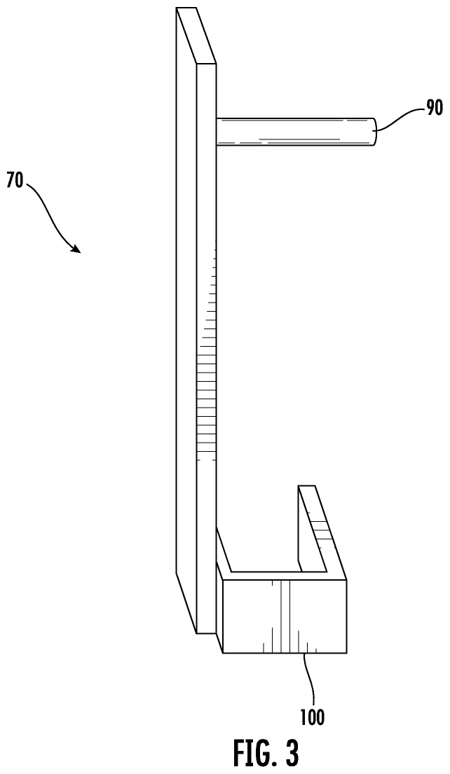

As shown in FIGS. 1-4, the present invention includes, in one embodiment, a roller attachment 10 that may be removably attached to the frame of a home gym system 80, a power cage, a squat rack or the like. The roller attachment 10 includes a frame member 20 and a rotating roller 30, as well as attachment means for removably attaching the roller attachment 10 to a home gym system 80.

In a preferred embodiment, the frame member 20 preferably includes at least one longitudinal support 40, with a pair of side supports 50 attached to the ends of the longitudinal support 40. The roller 30 is rotatably attached to the two side supports 50 of the frame member 20, and is preferably padded, or alternatively, is formed from a high-density foam, in order to provide a more comfortable experience for a user. Preferably, the roller 30 is attached to the frame member 20 by a threaded rod that serves as an axle member 60, which is attached between the side supports 50 by nuts and washers, although it should be understood that any suitable attachment mechanism may be used to attach the axle member 60 to the frame member 20.

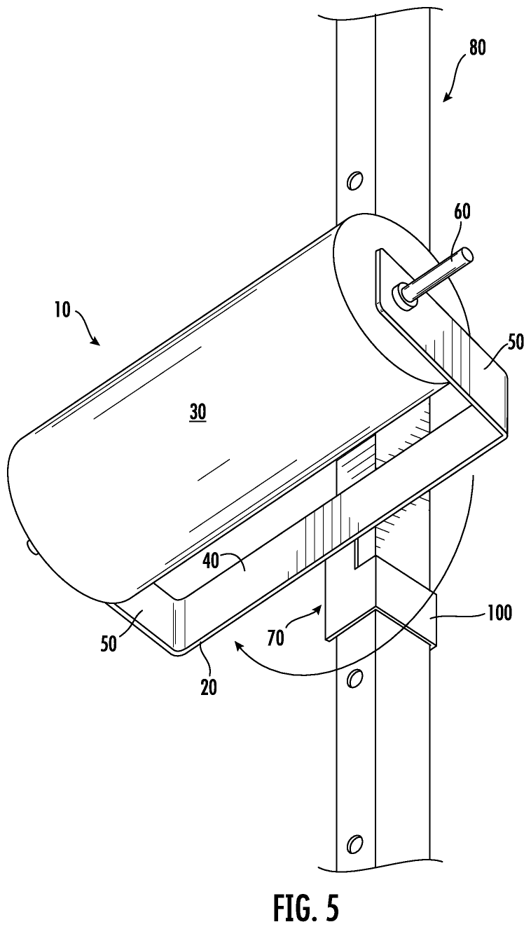

The attachment means for removably connecting the roller attachment to an exercise structure, in this embodiment, includes a bracket 70 having a fixed post member 90 that may be inserted into a hole disposed in the frame of a home gym system 80, cage, squat rack or the like. Some home gym systems 80 include frames having a series of holes disposed thereon, where the holes are spaced apart incrementally, so that attachments may be removably and interchangeably connected thereto at desired heights and locations. The bracket 70 may also include a generally C-shaped member 100 for engaging the sides of the frame of the home gym system 80 as shown in FIG. 5, so that the C-shaped member 100 maintains the proper position of the roller attachment 10 with respect to the home gym system 80 frame during operation, thus providing stability, and preventing the roller attachment 10 from rotating or becoming dislodged or improperly positioned while in use.

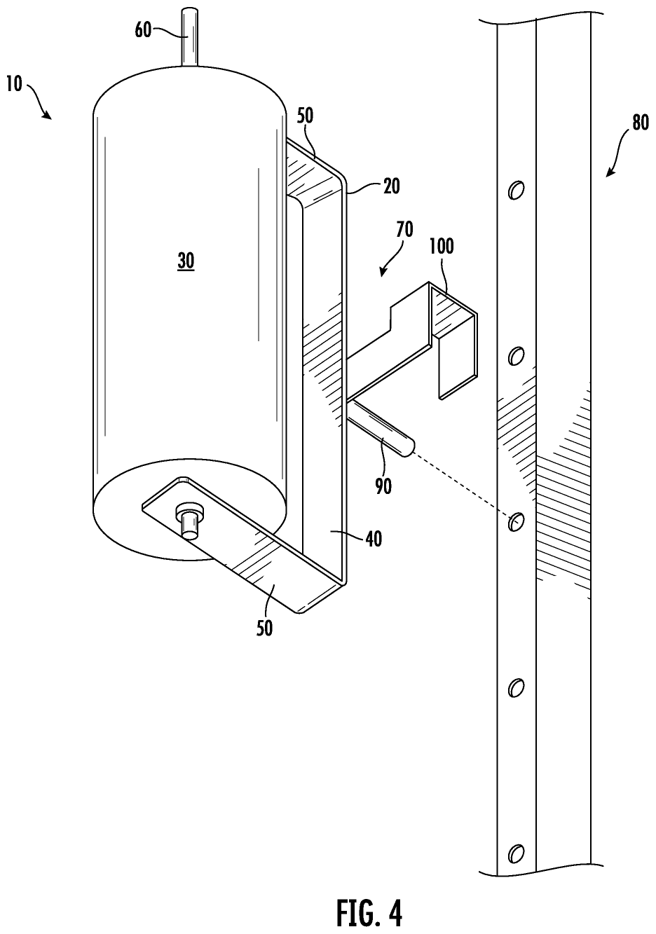

To attach this embodiment, a user orients the roller attachment 10 in a vertical orientation, slides the fixed post 90 of the bracket 70 into a hole on the frame of the home exercise gym system 80 as shown in FIG. 4, and then rotates the roller attachment 10 into a horizontal orientation so that the C-shaped member 100 engages three sides of the frame of the home exercise gym system 80, as shown in FIG. 5. To remove the roller attachment 10, the procedure is simply reversed, where the user rotates the roller attachment 10 to a vertical orientation, thereby disengaging the C-shaped member 100 from the frame of the home gym system 80, and then pulls the roller attachment 10 away from the frame of the home gym system to remove the fixed post member 90 from the hole disposed therein.

Once the roller attachment 10 is in place and positioned on the frame of a home gym system 80, the user may perform squat exercises with his or her back pressed against the roller 30. As the user performs squats, the roller 30 rotates in one direction when the user is moving downwardly into the squat position, and the roller 30 rotates in an opposed direction when the user is moving upwardly, back into an upright position. The roller attachment 10 helps the user to maintain balance, and further, assists in maintaining proper posture during the squatting exercises.

It should be understood that the roller attachment 10 may be removably attached to other structures, as desired, and is not limited to attachment only to home gym systems 80 and other exercise equipment structures. Additionally, the term ‘home gym system’ is used herein to include many types of exercise equipment, including squat racks, cages, power racks, and other structures that are used for exercise purposes. The attachment means may take any suitable form. For instance, if a user desired to attach the roller attachment 10 to a door frame, the attachment means may take the form of a clamp or vice-type mechanism. Other attachment means may include brackets having removable pins, similar to removable pins used to secure a trailer hitch to a trailer hitch sleeve on a vehicle, or may include other types of attachment means, such as bolts, snap-fit mechanisms, or any other suitable means for removable attachment to a support structure. It is contemplated that the attachment means may itself be removable from the frame member 20, so that various types of attachment means may be removably attached to the roller attachment frame member 20, interchangeably. Alternatively, the frame member and attachment means may be formed as a unitary, integrally formed, single piece unit, or may be removably assembled by component parts attached together, as recognized by those skilled in the art. It should also be noted that the roller attachment 10 may be used for other types of exercises, as desired.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A roller attachment exercise device comprising:
a frame member including a longitudinal support, a first side support attached to a first end of said longitudinal support, and a second side support attached to a second end of said longitudinal support;
a roller rotatably attached to said first and second side supports so that said roller may rotate about a longitudinal axis; and
attachment means for removably attaching said roller attachment exercise device to a fixed support.

2. The roller attachment exercise device set forth in claim 1, wherein said attachment means includes a fixed post that is attached to said frame member.

3. The roller attachment exercise device set forth in claim 2, wherein said attachment means also includes a C-shaped member that is attached to said frame member.

4. The roller attachment exercise device set forth in claim 1, wherein said roller includes padding about an outer surface thereof.

5. The roller attachment exercise device set forth in claim 1, wherein said fixed support is a frame of a home gym exercise system.
